(19) United States
(12) Patent Application Publication
(10) Pub. No.: US 2005/0139495 A1
(43) Pub. Date: Jun. 30, 2005

(54) Food vessel with media closure

(76) Inventor: Marcus B. Davis, Fresno, CA (US)

Correspondence Address: LAW OFFICE OF STEVEN B. LEAVITT, 9914 WATERVIEW PARKWAY, ROWLETT, TX, 75089, US

(21) Appl. No.: 11/022,619

(22) Filed: Dec. 27, 2004

Related U.S. Application Data
(60) Provisional application No. 60/532,836, filed on Dec. 26, 2003.

(51) Int. Cl. B01J 19/00

(52) U.S. Cl. 206/216; 206/459.5

(57) ABSTRACT

The present invention is a food vessel that contains a holding compartment for retaining an article of media. The food vessel is a plate or a bowl having at least one portion that is planar or flat wherein the planar or flat portion contains a holding compartment to protectively hold an article of media such as a music CD, CD-ROM, DVD, mini disc, business card CD, game piece, coupon, photograph, or any other type of media material that may be readily contained within the holding compartment of the food vessel.

The present application claims the benefit of to U.S. Provisional Patent Application entitled “FOOD VESSEL WITH MEDIA CLOSURE,” Application No. 60/532,836, filed on Dec. 26, 2003, which is incorporated herein by reference.

### BACKGROUND OF THE INVENTION

1. Technical Field

The present invention relates to food vessels that retain media. More particularly, the invention relates to a food vessel such as a plate or bowl that retains a piece of advertising media.

2. Description of Related Art

Merchandise containers, such as plastic or paper bags, cardboard boxes, or combinations thereof, are well known. It is often desirable to provide a compartment on the container for holding marketing media. Thereby, the container can be provided with an additional function of carrying a piece of media. For example, coupons and prizes are often included in food containers such as cereal boxes or snack chip bags.

Not only is desirable to provide a compartment on a container to display media, it is also desirable to include a piece of marketing media on an exterior portion of a container. For example, a coupon for an item may be adhered to the outside of a container holding the item to induce the purchase of the product by a consumer. Another example includes the use of one or more game pieces placed onto the exterior of a food container such as a sandwich box or a drink cup.

Electronic media storage devices such as music CDs, CD-ROMs, and DVDs have become common advertising media. One example of this has been to include a CD-ROM within a container holding another item such as software, hardware, or food items.

What is needed is an apparatus that will allow a variety of media, especially electronic media, to be displayed to a customer. If would be beneficial if the media was displayed in a food vessel whereby as a consumer eats or moves the food about the food vessel, the media would become visible. This would cause the consumer to become curious and interested in seeing the entirety of the media. Also, because the consumer typically needs to look at food numerous times during a meal in order to eat, it would be beneficial if the apparatus could provide a new platform for companies to market products to customers dining at a restaurant.

### SUMMARY OF THE INVENTION

The present invention is a food vessel that contains a holding compartment for retaining an article of media. A food vessel is a plate or a bowl having at least one portion that is planar or flat. The planar or flat portion contains a holding compartment to hold protectively an article of media. Typically, at least a portion of the food vessel and holding compartment may be made of paper, plastic, or metal. As to articles of media that may be readily contained within a holding compartment of a food vessel, these may include a music CD, CD-ROM, DVD, mini disc, business card CD, game piece, coupon, photograph, or any other type of media material.

As food is provided in the food vessel, the article of media is covered by the food such that the media is not viewable in whole or at least in part. As a consumer eats the food or moves the food about the plate, the media becomes visible through the food vessel.

In application, the food vessel of the present invention will have practical applications for several types of facilities offering food. Fast food and chain restaurants may offer marketing campaigns or product endorsements. Businesses may wish to use food vessels to promote themselves. Food vessels may be provided containing a party favor or memorabilia at special occasions such as weddings, anniversaries, birthday, graduation, and other parties. Also, the food vessel has applications for theme parks, movie theaters, sporting arenas, museums, and the like. In addition, the food vessel of the present invention may be constructed as a souvenir itself.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a top view of a food vessel in accordance with the present invention holding an article of media;

FIG. 2 is a side view of the food vessel shown in FIG. 1;

FIG. 3 is a top view of the food vessel shown in FIG. 1 without an article of media;

FIG. 4 is a bottom view of an alternative embodiment of the present invention of a food vessel holding an article of media;

FIG. 5 is a side view of the food vessel shown in FIG. 4 without an article of media; and

FIG. 6 is a side view of another alternative embodiment of the present invention of a food vessel for holding an article of media.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

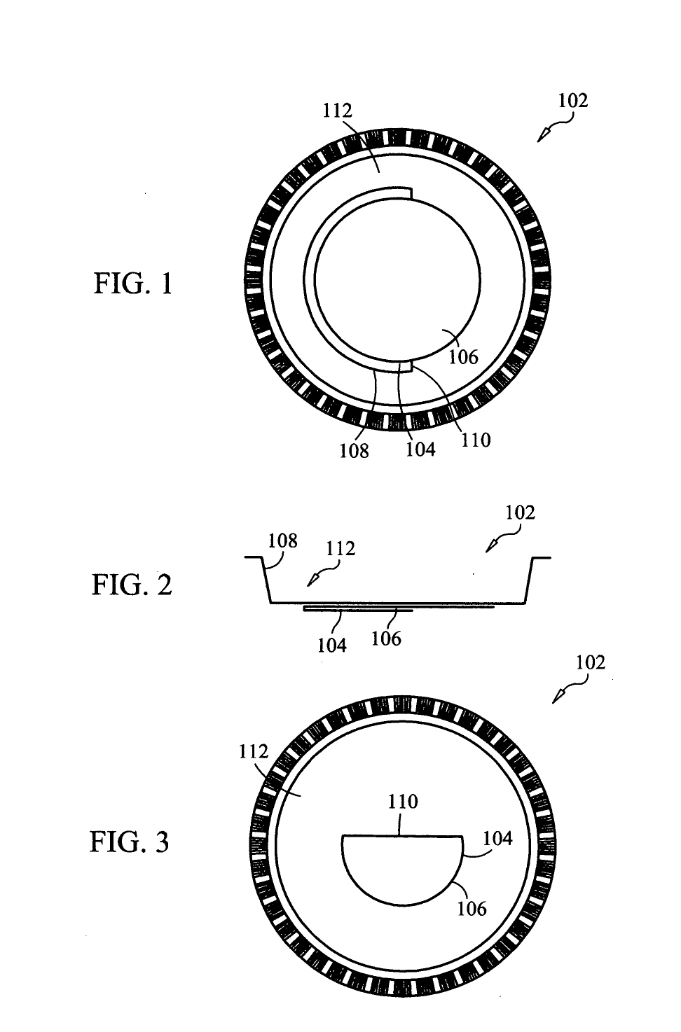

FIG. 1 shows a top view of food vessel 102, holding container 104, and article of media 106. Food vessel 102 is a container for holding food, liquid, or any material that is relatively easily removed from food vessel 102. The shape of food vessel 102 may be round, square, rectangular, triangular, or any other polygon. As to composition of food vessel 102, it may be comprised of paper, cardboard, plastic, metal, or any other type of material that would allow food vessel 102 to hold food, liquid, or other material that is relatively easily removed from food vessel 102 such as small tools, screws, nails, or sand. Preferably, at least a portion of food vessel 102 is made from a transparent or translucent material such as polystyrene, acrylic, polycarbonate, or some other similar transparent or translucent material. FIG. 2 is a side view of food vessel 102 illustrating lip 108. Lip 108 is for containing the material in food vessel 102. In one embodiment, food vessel 102 has at least one flat portion 112 which contains holding container 104

Holding container 104 is a container for holding media 106. The shape of holding container 104 may be round, square, rectangular, triangular, or any other polygon. Holding container 104 may be made of paper, cardboard, plastic, metal, or any other type of material that would allow holding container 104 to hold media 106. Preferably, at least a portion of holding container 104 is made from a transparent or translucent material such as polystyrene, acrylic, polycarbonate, or some other similar transparent or translucent material. As shown in FIG. 1, holding container 104 is a pocket. The pocket is horseshoe shaped and has round edge 108 and flat edge 110. Round edge 108 is attached to flat portion 112 of food vessel 102. Flat edge 110 is not attached to flat portion 112 and is able to allow media 106 to be inserted into and removed from holding container 104. FIG. 3 shows holding container 104 without an article of media.

Media 106 may be a music CD, CD-ROM, DVD, mini disc, business card CD, game piece, coupon, photograph, paper, plastic, or metal media, printed or graphical media, keys to a house or car, currency, or any other type of media material or promotional material that may be readily contained within holding container 104. Media 106 shown in FIG. 1 is a CD-ROM attached to a media paper with graphics.

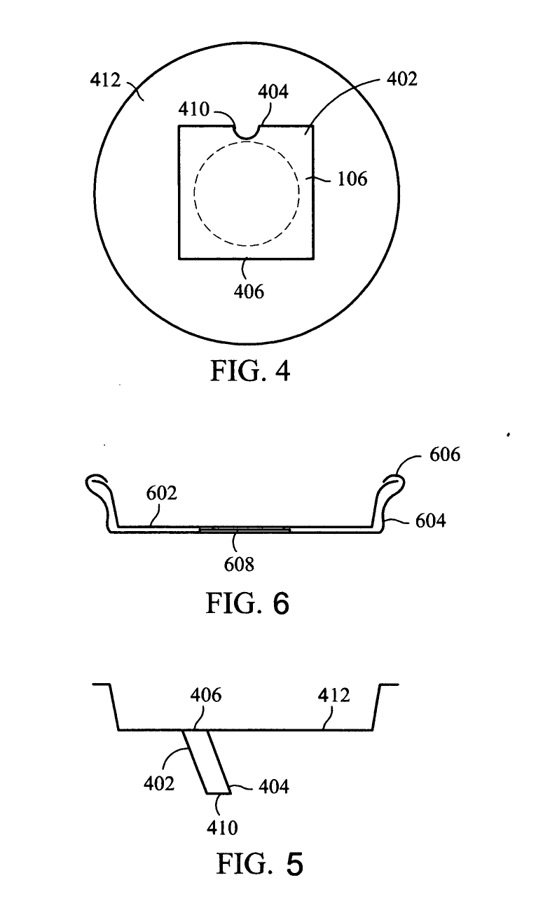

FIG. 4 shows food vessel 401 having at least one flat portion 412, and hinged door 402. Hinged door 402 has at lease one free edge 404 and an attachment edge 406. Attachment edge 406 is attached to flat portion 412.

When closed, free edge 404 of hinged door 402 is connected to flat portion 412 by adhesive, tab, perorations, or some other attachment means know in the art. At lest one free end 408 contains notch 410 to assist in removing free end 408 from flat portion 412. In use, a finger, thumb or some other object is placed in notch 410 to pull free edge 404 away from flat portion 412. As free edge 404 is pulled away from flat portion 412, attachment edge 406 rotates about an axis defined at edge 406 to allow access to the contents in holding container 104. FIG. 5 shows holding container 104 where free edge 404 has been disconnected from flat portion 412.

Container 401 has a rectangular profile but may be round, square, triangular shaped, or any other polygon.

FIG. 6 shows an alternative embodiment whereby food vessel 602 is secured to holding container 604 by locking member 606 extending from holding container 604.

Holding container 604 contains flat portion 608 and locking member 606. Locking member 606 is a snap lock or some other similar type snap closure known in the art.

In use, media 608 is placed in holding container 604. After inserting the media 608 into holding container 604, food vessel 602 is pressed down onto holding container 604 such that locking member 606 engages with and secures food vessel 602 to holding container 604. Thereby, food vessel 602 rests upon media 608 while being securely retained with locking member 606 to holding container 604. With this embodiment, no access door is required on food vessel 602 or holding container 604. To extract media 608, downward pressure is applied to locking member 606 to release food vessel 602 and allow access to media 608.

Although the invention has been described with reference to one or more preferred embodiments, the description is not to be construed in a limiting sense. There is modification of the disclosed embodiments, as well as alternative embodiments of this invention, which will be apparent to persons of ordinary skill in the art and various changes in form and detail may be made therein without departing from the spirit and scope of the invention. The invention shall be viewed as limited only by reference to the following claims.

1. A food vessel for displaying media, comprising:
a top portion of the food vessel;
a bottom portion of the food vessel connected to the top portion; and
a media closure between the top and bottom portions of the food vessel adaptively constructed to retain an article of media.

2. The food vessel of claim 1 wherein the media closure is a pocket.

3. The food vessel of claim 1 further comprising an accessible cover formed into the bottom portion of the food vessel over the media closure.

4. The food vessel of claim 2 wherein the accessible cover is a hinged door.

5. The food vessel of claim 2 wherein the accessible cover is a sliding cover.

6. The food vessel of claim 1 wherein the media closure is bounded by a wall.

7. The food vessel of claim 1 wherein the food vessel is a plate.

8. The food vessel of claim 1 wherein the food vessel is a bowl.

9. The food vessel of claim 1 wherein at least a portion of the article of media closure is visible through the top portion of the food vessel.

10. The food vessel of claim 1 further comprising at least one media closure between the top and bottom portions of the food vessel adaptively constructed to retain an article of media.

11. The food vessel of claim 1 wherein the article of media is a music CD.

12. The food vessel of claim 1 wherein the article of media is a CD-ROM.

13. A method for displaying media in a food vessel, the method comprising the steps of:
inserting an article of media in a food vessel wherein the food vessel contains:
a top portion;
a bottom portion connected to the top portion; and
a media closure between the top and bottom portions of the food vessel adaptively constructed to retain the article of media.

14. The method of claim 13 wherein the media closure is a pocket.

15. The method of claim 13 wherein the food vessel is a plate.

16. The method of claim 13 wherein the food vessel is a bowl.

17. The method of claim 13 wherein at least a portion of the article of media closure is visible through the top portion of the food vessel.

18. The method of claim 13 wherein the article of media is a music CD.

19. The method of claim 13 wherein the article of media is a CD-ROM.

20. A food vessel for displaying media, comprising:
a top portion of the food vessel;
a bottom portion of the food vessel that is adapted to receive the top portion; and
a media closure between the top and bottom portions of the food vessel adaptively constructed to retain an article of media.
